(19) United States
(12) Patent Application Publication
(10) Pub. No.: US 2019/0147539 A1
(43) Pub. Date: May 16, 2019

(54) METHOD AND APPARATUS FOR OUTPUTTING INFORMATION

(71) Applicant: Baidu Online Network Technology (Beijing) Co., Ltd., Beijing (CN)

(72) Inventors: Mingyang Dai, Beijing (CN); Lei Han, Beijing (CN); Chuanxin Bian, Beijing (CN); Shengwen Yang, Beijing (CN)

(21) Appl. No.: 16/133,214

(22) Filed: Sep. 17, 2018

(30) Foreign Application Priority Data
Nov. 15, 2017 (CN) 201711131690.4

(51) Int. Cl. G06Q 40/08; B60W 40/09; H04L 29/08

(52) U.S. Cl. CPC G06Q 40/08; H04L 67/22; H04L 67/306; B60W 40/09

(57) ABSTRACT

Embodiments of the present disclosure disclose a method and apparatus for outputting information. The method includes: acquiring at least one personal attribute characteristic and a vehicle attribute characteristic of a target user; importing, for each personal attribute characteristic of the at least one personal attribute characteristic, the personal attribute characteristic into a pre-trained scoring model to obtain a score corresponding to the personal attribute characteristic; defining a characteristic vector obtained by splicing the score corresponding to each personal attribute characteristic of the at least one personal attribute characteristic and the vehicle attribute characteristic as a characteristic vector for prediction; importing the characteristic vector for prediction into at least one of three pre-trained calculation models to obtain a prediction value corresponding to each calculation model of the at least one calculation model into which the characteristic vector for prediction is imported; and outputting at least one obtained prediction value.

### CROSS-REFERENCE TO RELATED APPLICATIONS

This application is related to and claims priority from Chinese Application No. 201711131690.4, filed on Nov. 15, 2017 and entitled “Method and Apparatus for Outputting Information,” the entire disclosure of which is hereby incorporated by reference.

### TECHNICAL FIELD

Embodiments of the present disclosure relate to the field of computer technology, specifically relate to the field of Internet technology, and more specifically relate to a method and apparatus for outputting information.

### BACKGROUND

With the development of the Internet and the data mining technology, currently, there are various kinds of user characteristic information obtained by data mining the user's Internet-related data.

### SUMMARY

Embodiments of the present disclosure propose a method and apparatus for outputting information.

In a first aspect, the embodiments of the present disclosure provide a method for outputting information, including: acquiring at least one personal attribute characteristic and a vehicle attribute characteristic of a target user; importing, for each personal attribute characteristic of the at least one personal attribute characteristic, the personal attribute characteristic into a pre-trained scoring model to obtain a score corresponding to the personal attribute characteristic, the scoring model being used to represent a corresponding relationship between the personal attribute characteristic and the score; defining a characteristic vector obtained by splicing the score corresponding to each personal attribute characteristic of the at least one personal attribute characteristic and the vehicle attribute characteristic as a characteristic vector for prediction; importing the characteristic vector for prediction into at least one of three pre-trained calculation models to obtain a prediction value corresponding to each calculation model of the at least one calculation model into which the characteristic vector for prediction is imported, the three calculation models including: a vehicle accident occurrence frequency calculation model, an average vehicle accident loss value calculation model, and a vehicle accident loss value within a preset period calculation model, the vehicle accident occurrence frequency calculation model being used to represent a corresponding relationship between the characteristic vector and a vehicle accident occurrence frequency, the average vehicle accident loss value calculation model being used to represent a corresponding relationship between the characteristic vector and an average vehicle accident loss value, and the vehicle accident loss value within the preset period calculation model being used to represent a corresponding relationship between the characteristic vector and a vehicle accident loss value within preset time; and outputting at least one obtained prediction value.

In some embodiments, the at least one personal attribute characteristic includes at least one of the following: a natural personal attribute characteristic or a network behavior characteristic, and the network behavior characteristic includes at least one of the following: an electronic map navigation characteristic, an interests profile characteristic, an address characteristic, a common application characteristic, a credit score characteristic or a network search topic characteristic.

In some embodiments, the vehicle accident occurrence frequency calculation model is a Poisson distribution, the average vehicle accident loss value calculation model is a gamma distribution, and the vehicle accident loss value within the preset period calculation model is a Tweedie distribution.

In some embodiments, the vehicle accident occurrence frequency calculation model is obtained by: acquiring an initial value of a parameter of the Poisson distribution and a predetermined first sample data set, wherein each piece of sample data in the first sample data set includes a characteristic vector of a user and a historical vehicle accident occurrence frequency of the user, wherein the characteristic vector of the user is obtained by splicing the score corresponding to the each personal attribute characteristic of the at least one personal attribute characteristic of the user and the vehicle attribute characteristic; using the characteristic vector of the user in each piece of sample data in the first sample data set as input data, and the historical vehicle accident occurrence frequency of the user in the sample data as corresponding output data to train the parameter of the Poisson distribution; and defining the trained Poisson distribution as the pre-trained vehicle accident occurrence frequency calculation model.

In some embodiments, the average vehicle accident loss value calculation model is obtained by: acquiring an initial value of a parameter of the gamma distribution and a predetermined second sample data set, wherein each piece of sample data in the second sample data set includes a characteristic vector of a user and a historical average vehicle accident loss value of the user, wherein the characteristic vector of the user is obtained by splicing the score corresponding to the each personal attribute characteristic of the at least one personal attribute characteristic of the user and the vehicle attribute characteristic; using the characteristic vector of the user in each piece of sample data in the second sample data set as input data, and the historical average vehicle accident loss value of the user in the sample data as corresponding output data to train the parameter of the gamma distribution; and defining the trained gamma distribution as the pre-trained average vehicle accident loss value calculation model.

In some embodiments, the vehicle accident loss value within the preset period calculation model is obtained by: acquiring an initial value of a parameter of the Tweedie distribution and a predetermined third sample data set, wherein each piece of sample data in the third sample data set includes a characteristic vector of a user and a historical vehicle accident loss value within preset time of the user, wherein the characteristic vector of the user is obtained by splicing the score corresponding to the each personal attribute characteristic of the at least one personal attribute characteristic of the user and the vehicle attribute characteristic; using the characteristic vector of the user in each piece of sample data in the third sample data set as input data, and the historical vehicle accident loss value within preset time of the user in the sample data as corresponding output data to train the parameter of the Tweedie distribution; and defining the trained Tweedie distribution as the pre-trained vehicle accident loss value within preset time calculation model.

In some embodiments, the vehicle attribute characteristic includes at least one of the following: a vehicle model, a number of compartments, a vehicle displacement, or historical vehicle accident related information.

In a second aspect, the embodiments of the present disclosure provide an apparatus for outputting information, including: an acquisition unit, configured to acquire at least one personal attribute characteristic and a vehicle attribute characteristic of a target user; a scoring unit, configured to import, for each personal attribute characteristic of the at least one personal attribute characteristic, the personal attribute characteristic into a pre-trained scoring model to obtain a score corresponding to the personal attribute characteristic, the scoring model being used to represent a corresponding relationship between the personal attribute characteristic and the score; a splicing unit, configured to define a characteristic vector obtained by splicing the score corresponding to each personal attribute characteristic of the at least one personal attribute characteristic and the vehicle attribute characteristic as a characteristic vector for prediction; a prediction unit, configured to import the characteristic vector for prediction into at least one of three pre-trained calculation models to obtain a prediction value corresponding to each calculation model of the at least one calculation model into which the characteristic vector for prediction is imported, the three calculation models including: a vehicle accident occurrence frequency calculation model, an average vehicle accident loss value calculation model, and a vehicle accident loss value within a preset period calculation model, the vehicle accident occurrence frequency calculation model being used to represent a corresponding relationship between the characteristic vector and a vehicle accident occurrence frequency, the average vehicle accident loss value calculation model being used to represent a corresponding relationship between the characteristic vector and an average vehicle accident loss value, and the vehicle accident loss value within the preset period calculation model being used to represent a corresponding relationship between the characteristic vector and a vehicle accident loss value within preset time; and an outputting unit, configured to output at least one obtained prediction value.

In some embodiments, the at least one personal attribute characteristic includes at least one of the following: a natural personal attribute characteristic or a network behavior characteristic, and the network behavior characteristic includes at least one of the following: an electronic map navigation characteristic, an interests profile characteristic, an address characteristic, a common application characteristic, a credit score characteristic or a network search topic characteristic.

In some embodiments, the vehicle accident occurrence frequency calculation model is a Poisson distribution, the average vehicle accident loss value calculation model is a gamma distribution, and the vehicle accident loss value within the preset period calculation model is a Tweedie distribution.

In some embodiments, the vehicle accident occurrence frequency calculation model is obtained by: acquiring an initial value of a parameter of the Poisson distribution and a predetermined first sample data set, wherein each piece of sample data in the first sample data set includes a characteristic vector of a user and a historical vehicle accident occurrence frequency of the user, wherein the characteristic vector of the user is obtained by splicing the score corresponding to the each personal attribute characteristic of the at least one personal attribute characteristic of the user and the vehicle attribute characteristic; using the characteristic vector of the user in each piece of sample data in the first sample data set as input data, and the historical vehicle accident occurrence frequency of the user in the sample data as corresponding output data to train the parameter of the Poisson distribution; and defining the trained Poisson distribution as the pre-trained vehicle accident occurrence frequency calculation model.

In some embodiments, the average vehicle accident loss value calculation model is obtained by: acquiring an initial value of a parameter of the gamma distribution and a predetermined second sample data set, wherein each piece of sample data in the second sample data set includes a characteristic vector of a user and a historical average vehicle accident loss value of the user, wherein the characteristic vector of the user is obtained by splicing the score corresponding to the each personal attribute characteristic of the at least one personal attribute characteristic of the user and the vehicle attribute characteristic; using the characteristic vector of the user in each piece of sample data in the second sample data set as input data, and the historical average vehicle accident loss value of the user in the sample data as corresponding output data to train the parameter of the gamma distribution; and defining the trained gamma distribution as the pre-trained average vehicle accident loss value calculation model.

In some embodiments, the vehicle accident loss value within the preset period calculation model is obtained by: acquiring an initial value of a parameter of the Tweedie distribution and a predetermined third sample data set, wherein each piece of sample data in the third sample data set includes a characteristic vector of a user and a historical vehicle accident loss value within preset time of the user, wherein the characteristic vector of the user is obtained by splicing the score corresponding to the each personal attribute characteristic of the at least one personal attribute characteristic of the user and the vehicle attribute characteristic; using the characteristic vector of the user in each piece of sample data in the third sample data set as input data, and the historical vehicle accident loss value within preset time of the user in the sample data as corresponding output data to train the parameter of the Tweedie distribution; and defining the trained Tweedie distribution as the pre-trained vehicle accident loss value within preset time calculation model.

In some embodiments, the vehicle attribute characteristic includes at least one of the following: a vehicle model, a number of compartments, a vehicle displacement, or historical vehicle accident related information.

In a third aspect, the embodiments of the present disclosure provide an electronic device, including: one or more processors; and a storage apparatus, for storing one or more programs, the one or more programs, when executed by the one or more processors, cause the one or more processors to implement the method according to any one of the embodiments in the first aspect.

In a fourth aspect, the embodiments of the present disclosure provide a computer readable storage medium, storing a computer program thereon, the program, when executed by a processor, implements the method according to any one of the embodiments in the first aspect.

The method and apparatus for outputting information provided by the embodiments of the present disclosure achieve dimension reduction by using a method of scoring each personal attribute characteristic of at least one personal attribute characteristic of the target user, realize compressing a personal attribute characteristic with high and sparse characteristic dimension into an one-dimensional score, then splice the score corresponding to each personal attribute characteristic of the at least one personal attribute characteristic and a vehicle attribute characteristic with low and dense characteristic dimension, so that the characteristic vector obtained after the splicing is a characteristic vector with low and dense characteristic dimension. Then, the characteristic vector obtained after the splicing is defined as a characteristic vector for prediction. The characteristic vector for prediction is imported into at least one of three pre-trained calculation models to obtain a prediction value corresponding to each calculation model of the at least one calculation model into which the characteristic vector for prediction is imported, and the at least one obtained prediction value is outputted. Therefore, the personal attribute characteristic with high and sparse characteristic dimension is effectively utilized, and at least one of the three prediction values is obtained by combining the vehicle attribute characteristic, thereby improving the content richness of the information output.

### BRIEF DESCRIPTION OF THE DRAWINGS

After reading detailed descriptions of non-limiting embodiments with reference to the following accompanying drawings, other features, objectives and advantages of the present disclosure will become more apparent:

FIG. 1 is an architecture diagram of an exemplary system in which the present disclosure may be implemented;

FIG. 2 is a flowchart of an embodiment of a method for outputting information according to the present disclosure;

FIG. 3 is a schematic diagram of an application scenario of the method for outputting information according to the present disclosure;

FIG. 4 is a schematic structural diagram of an embodiment of an apparatus for outputting information according to the present disclosure; and

FIG. 5 is a schematic structural diagram of a computer system adapted to implement an electronic device of embodiments of the present disclosure.

### DETAILED DESCRIPTION OF EMBODIMENTS

The present disclosure will be further described below in detail in combination with the accompanying drawings and the embodiments. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should be noted that the embodiments in the present disclosure and the features in the embodiments may be combined with each other on a non-conflict basis. The present disclosure will be described below in detail with reference to the accompanying drawings and in combination with the embodiments.

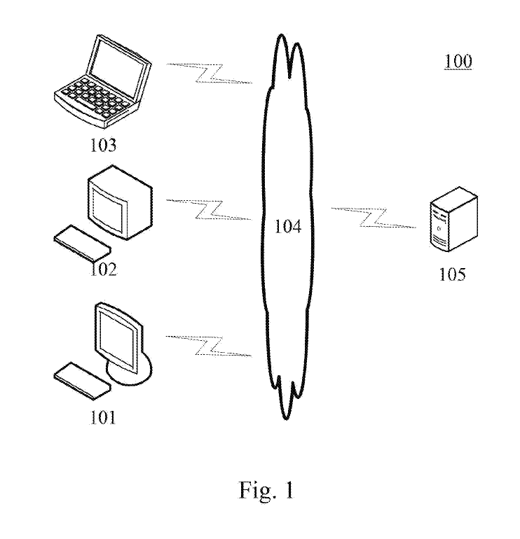

FIG. 1 shows an architecture of an exemplary system 100 which may be used by a method for outputting information or an apparatus for outputting information according to the embodiments of the present disclosure.

As shown in FIG. 1, the system architecture 100 may include terminal devices 101, 102 and 103, a network 104 and a server 105. The network 104 serves as a medium providing a communication link between the terminal devices 101, 102 and 103, and the server 105. The network 104 may include various types of connections, such as wired or wireless transmission links, or optical fibers.

The user may use the terminal devices 101, 102 and 103 to interact with the server 105 through the network 104, in order to transmit or receive messages, etc. Various client applications, such as vehicle insurance pricing applications, webpage browser applications, shopping applications, search applications, instant messaging tools, mailbox clients, and social platform software may be installed on the terminal devices 101, 102 and 103.

The terminals 101, 102 and 103 may be various electronic devices having display screens, including but not limited to, smart phones, tablet computers, laptop computers, and desktop computers.

The server 105 may be a server providing various services, for example, a backend server providing support for vehicle insurance pricing applications displayed on the terminal devices 101, 102 or 103. The backend server may perform processing such as analyzing on data such as received data acquiring request, and return a processing result (for example, a person attribute related characteristic and a vehicle attribute characteristic) to the terminal devices.

It should be noted that the method for outputting information according to the embodiments of the present disclosure is generally executed by the terminal devices 101, 102 or 103. Accordingly, the apparatus for outputting information is generally installed on the terminal devices 101, 102 or 103.

It should be appreciated that the numbers of the terminal devices, the networks and the servers in FIG. 1 are merely illustrative. Any number of terminal devices, networks and servers may be provided based on the actual requirements.

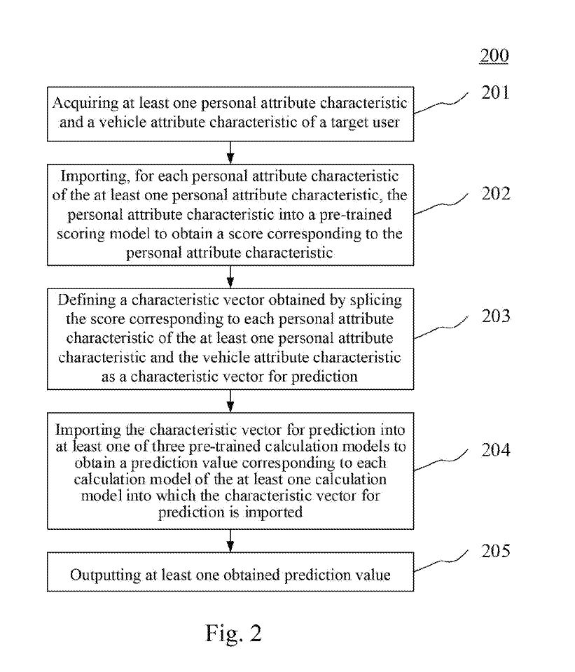

With further reference to FIG. 2, a flow 200 of an embodiment of the method for outputting information according to the present disclosure is illustrated. The method for outputting information includes the following steps.

Step 201, acquiring at least one personal attribute characteristic and a vehicle attribute characteristic of a target user.

In the present embodiment, the electronic device (e.g., the terminal device as shown in FIG. 1) on which the method for outputting information is performed may acquire at least one personal attribute characteristic and a vehicle attribute characteristic of a target user locally or remotely from other electronic devices (e.g., the server as shown in FIG. 1) connected to the electronic device via a network. At least one personal attribute characteristic of the target user and the vehicle attribute characteristic may be stored in the electronic device locally or in other electronic devices connected to the electronic device via the network.

In the present embodiment, the target user may be any specified user in a preset user set, and may acquire the personal attribute characteristic and the vehicle attribute characteristic of the specified user. For example, the target user may be a vehicle insurance user of a vehicle insurance company and a user in the preset user set, and the vehicle insurance user and the user in the preset user set may be determined to be the same entity user by using a preset rule. For example, the preset rule may be that at least one of three pieces of information reserved by the vehicle insurance user in the insurance policy of the vehicle insurance company is the same as the corresponding information of the user in the preset user set, and the three pieces of information may include the cell phone number, the ID number and the name.

In the present embodiment, the personal attribute characteristic of the target user is a characteristic obtained by performing characteristic extraction on attribute values of various attributes of the target user as a person. For example, attributes of a person may include name, gender, date of birth, cell phone number, occupation, income, hobbies, residential city, driving habits, and the like. As an example, the personal attribute characteristic may be a user underlying characteristic that is unearthed by performing processing such as collecting, storing, processing, analyzing, monitoring, and alerting on big data in advance.

In the present embodiment, the vehicle attribute characteristic of the target user is a characteristic obtained by performing characteristic extraction on attribute values of various attributes of the vehicle owned by the target user. For example, the attributes of the vehicle may include the owner's name, the owner's gender, the owner's date of birth, the owner's cell phone number, the vehicle model, the number of compartments, the vehicle displacement, and the like. For example, the vehicle attribute characteristic of the target user may be acquired from the vehicle insurance company.

In some alternative implementations of the present embodiment, the vehicle attribute characteristic may include at least one of the following: the vehicle model, the number of compartments, the vehicle displacement, or historical vehicle accident related information. Here, the historical vehicle accident related information may include an NCD coefficient corresponding to the vehicle insurance, a vehicle historical annual number of risks, a vehicle historical average amount of compensation and a vehicle historical annualized amount of compensation.

In some alternative implementations of the present embodiment, the at least one personal attribute characteristic may include at least one of the following: a natural personal attribute characteristic and a network behavior characteristic. Here, the natural personal attribute characteristic may be a characteristic obtained by performing characteristic extraction on attribute values of natural attributes of a natural person. For example, the natural attributes may be attributes associated with a person's own biological characteristics such as date of birth, gender, and physical condition. The network behavior characteristic may be a characteristic obtained by performing characteristic extraction on behavior data of the user on the network, for example, data of an electronic map used by the user for navigation, webpage browsed and keyword inputted by the user on a website, shopping data and evaluation data of the user using an E-shopping application, payment data of the user using a payment application, and input information of the user on a car related website, etc. Here, the network behavior characteristic may include at least one of the following: an electronic map navigation characteristic, an interests profile characteristic, an address characteristic, a common application characteristic, a credit score characteristic and a network search topic characteristic. Alternatively, the electronic map navigation characteristic may include, but is not limited to, at least one of the following: mileage, fatigue during driving, frequency of sudden acceleration, frequency of sudden deceleration, frequency of sharp turns, urban portrait, weather, backlight driving, road type, electronic eye, viaduct and intersection type. Here, the mileage may be the sum of the distance between the destination and the place of departure for each navigation of the user using the electronic map for navigation within a preset time period. Fatigue during driving may be judged by the time and frequency of the user using the electronic map for navigation. The frequency of sudden acceleration, frequency of sudden deceleration, and frequency of sharp turns may also be obtained by statistical analysis of positioning information of the user terminal during the process of using the electronic map for navigation by the user. Similarly, other electronic map navigation characteristics may be obtained by navigation information during the process of using the electronic map for navigation by the user and the positioning information of the user terminal.

Step 202, importing, for each personal attribute characteristic of the at least one personal attribute characteristic, the personal attribute characteristic into a pre-trained scoring model to obtain a score corresponding to the personal attribute characteristic.

In the present embodiment, based on the at least one personal attribute characteristic obtained in step 201, the electronic device may import, for each personal attribute characteristic of the at least one personal attribute characteristic, the personal attribute characteristic into a pre-trained scoring model to obtain a score corresponding to the personal attribute characteristic. Here, the scoring model is used to represent a corresponding relationship between the personal attribute characteristic and the score.

Since the personal attribute characteristic is a characteristic obtained by performing characteristic extraction on attribute values of attributes of a person, the characteristic dimension of the characteristic is high (for example, usually the characteristic dimension of the personal attribute characteristic may reach several hundred thousand dimensions) and sparse (not all personal attribute characteristics may be valued). In order to reduce the characteristic dimension of the personal attribute characteristic, each personal attribute characteristic may be imported into the scoring model to obtain a score corresponding to the personal attribute characteristic, thus the high-dimensional personal attribute characteristic is compressed to an one-dimensional score.

In some alternative implementations of the present embodiment, the same scoring model may be pre-trained for each personal attribute characteristic so that each personal attribute characteristic may be imported into the same scoring model.

In some alternative implementations of the present embodiment, different scoring models may be pre-trained for different personal attribute characteristics, so that each personal attribute characteristic may be imported into a scoring model corresponding to the personal attribute characteristic to obtain a score corresponding to the personal attribute characteristic.

As an example, the scoring model may be obtained by the following first scoring model training steps.

First, an initial scoring model and a predetermined fourth sample data set may be acquired. Here, each piece of sample data in the fourth sample data set includes a personal attribute characteristic of the user and the vehicle accident occurrence frequency residual of the user. Here, the vehicle accident occurrence frequency residual of the user is the difference between the historical vehicle accident occurrence frequency of the user (for example, a frequency of the vehicle in danger) and the predicted vehicle accident occurrence frequency of the user.

Then, the personal attribute characteristic in each piece of sample data in the fourth sample data set may be used as input data, and the vehicle accident occurrence frequency residual of the user may be used as corresponding output data to train the initial scoring model using a machine learning method.

Finally, the trained initial scoring model may be defined as the pre-trained scoring model.

As an example, the scoring model may also be obtained by the following second scoring model training steps.

First, an initial scoring model and a predetermined fifth sample data set may be acquired. Here, each piece of sample data in the fifth sample data set includes a personal attribute characteristic of the user and the historical vehicle accident occurrence frequency of the user (for example, the historical frequency of the vehicle in danger).

Then, the personal attribute characteristic in each piece of sample data in the fifth sample data set may be used as input data, and the historical vehicle accident occurrence frequency of the user may be used as corresponding output data to train the initial scoring model using the machine learning method.

Finally, the trained initial scoring model may be defined as the pre-trained scoring model.

As an example, the scoring model may also be obtained by the following third scoring model training steps.

First, an initial scoring model and a predetermined sixth sample data set may be acquired. Here, each piece of sample data in the sixth sample data set includes a personal attribute characteristic of the user and the historical vehicle accident compensation rate of the user (for example, the historical vehicle insurance compensation rate).

Then, the personal attribute characteristic in each piece of sample data in the sixth sample data set may be used as input data, and the historical vehicle accident compensation rate of the user may be used as corresponding output data to train the initial scoring model using the machine learning method.

Finally, the trained initial scoring model may be defined as the pre-trained scoring model.

As an example, the scoring model may also be obtained by the following fourth scoring model training steps.

First, an initial scoring model and a predetermined seventh sample data set may be acquired. Here, each piece of sample data in the seventh sample data set includes a personal attribute characteristic of the user and the historical vehicle accident loss value of the user in preset time (for example, the historical vehicle insurance annualized amount of compensation).

Then, the personal attribute characteristic in each piece of sample data in the seventh sample data set may be used as input data, and the historical vehicle accident loss value in preset time of the user may be used as corresponding output data to train the initial scoring model using the machine learning method.

Finally, the trained initial scoring model may be defined as the pre-trained scoring model.

As an example, the scoring model may also be obtained by the following fifth scoring model training steps.

First, an initial scoring model and a predetermined eighth sample data set may be acquired. Here, each piece of sample data in the eighth sample data set includes a personal attribute characteristic of the user and the historical vehicle accident standard compensation rate of the user (for example, the historical vehicle insurance standard compensation rate).

Then, the personal attribute characteristic in each piece of sample data in the eighth sample data set may be used as input data, and the historical vehicle accident standard compensation rate of the user may be used as corresponding output data to train the initial scoring model using the machine learning method.

Finally, the trained initial scoring model may be defined as the pre-trained scoring model.

Here, the initial scoring model may be various machine learning models, and may be, for example, a Binary Classification model, a Tweedie Regression model, or the like.

Step 203, defining a characteristic vector obtained by splicing the score corresponding to each personal attribute characteristic of the at least one personal attribute characteristic and the vehicle attribute characteristic as a characteristic vector for prediction.

In the present embodiment, the electronic device on which the method for outputting information is performed may splice the score corresponding to each personal attribute characteristic of the at least one personal attribute characteristic and the vehicle attribute characteristic, and define a characteristic vector obtained by splicing as a characteristic vector for prediction.

Step 204, importing the characteristic vector for prediction into at least one of three pre-trained calculation models to obtain a prediction value corresponding to each calculation model of the at least one calculation model into which the characteristic vector for prediction is imported.

In the present embodiment, the electronic device may import the characteristic vector for prediction determined in step 203 into at least one of three pre-trained calculation models to obtain a prediction value corresponding to each calculation model of the at least one calculation model into which the characteristic vector for prediction is imported. Here, the three calculation models may include: a vehicle accident occurrence frequency calculation model, an average vehicle accident loss value calculation model, and a vehicle accident loss value within a preset period calculation model. The vehicle accident occurrence frequency calculation model is used to represent a corresponding relationship between the characteristic vector and a vehicle accident occurrence frequency. The average vehicle accident loss value calculation model is used to represent a corresponding relationship between the characteristic vector and an average vehicle accident loss value. The vehicle accident loss value within the preset period calculation model is used to represent a corresponding relationship between the characteristic vector and a vehicle accident loss value within preset time.

As an example, the vehicle accident occurrence frequency calculation model may be a corresponding relationship table pre-defined by a technical personnel based on statistics on a large number of characteristic vectors and vehicle accident occurrence frequencies (e.g., the vehicle accident frequencies), and storing corresponding relationships between a plurality of characteristic vectors and vehicle accident occurrence frequencies. The vehicle accident occurrence frequency calculation model may also be a calculation formula for representing the vehicle accident occurrence frequency obtained by numerically calculating one or more values in the characteristic vectors, preset by a technical personnel based on statistics on a large amount of data and stored into the electronic device.

In some alternative implementations of the present embodiment, the vehicle accident occurrence frequency calculation model may be the Poisson distribution.

Based on the above alternative implementations, in some alternative implementations of the present embodiment, the vehicle accident occurrence frequency calculation model may be obtained by using the following first training steps.

First, an initial value of a parameter of the Poisson distribution and a predetermined first sample data set may be acquired. Here, each piece of sample data in the first sample data set includes a characteristic vector of a user and a historical vehicle accident occurrence frequency of the user (for example, a historical frequency of the vehicle in danger). Here, the characteristic vector of the user is a characteristic vector obtained by splicing a score corresponding to each personal attribute characteristic of the at least one personal attribute characteristic of the user and the vehicle attribute characteristic.

Then, the characteristic vector of the user in each piece of sample data in the first sample data set is used as input data, and the historical vehicle accident occurrence frequency of the user in the sample data is used as corresponding output data to train the parameter of the Poisson distribution.

Finally, the trained Poisson distribution is defined as the pre-trained vehicle accident occurrence frequency calculation model.

As an example, the average vehicle accident loss value calculation model may also be a corresponding relationship table pre-defined by a technical personnel based on statistics on a large number of characteristic vectors and average vehicle accident loss values (e.g., the vehicle insurance case average compensation amount), and storing corresponding relationships between a plurality of characteristic vectors and average vehicle accident loss values. The average vehicle accident loss value calculation model may also be a calculation formula for representing the average vehicle accident loss value obtained by numerically calculating one or more values in the characteristic vectors, preset by a technical personnel based on statistics on a large amount of data and stored into the electronic device.

In some alternative implementations of the present embodiment, the average vehicle accident loss value calculation model may be the gamma distribution.

Based on the above alternative implementations, in some alternative implementations of the present embodiment, the average vehicle accident loss value calculation model may be obtained by using the following second training steps.

First, an initial value of a parameter of the gamma distribution and a predetermined second sample data set may be acquired. Here, each piece of sample data in the second sample data set includes a characteristic vector of a user and a historical average vehicle accident loss value of the user (for example, a historical vehicle insurance case average compensation amount). Here, the characteristic vector of the user is a characteristic vector obtained by splicing a score corresponding to each personal attribute characteristic of the at least one personal attribute characteristic of the user and the vehicle attribute characteristic.

Then, the characteristic vector of the user in each piece of sample data in the second sample data set is used as input data, and the historical average vehicle accident loss value of the user in the sample data is used as corresponding output data to train the parameter of the gamma distribution.

Finally, the trained gamma distribution is defined as the pre-trained average vehicle accident loss value calculation model.

As an example, the vehicle accident loss value within the preset period calculation model may also be a corresponding relationship table pre-defined by a technical personnel based on statistics on a large number of characteristic vectors and vehicle accident loss values within preset time (e.g., the vehicle insurance annualized compensation amount), and storing corresponding relationships between a plurality of characteristic vectors and vehicle accident loss values within preset time. The vehicle accident loss value within the preset period calculation model may also be a calculation formula for representing the vehicle accident loss value within preset time obtained by numerically calculating one or more values in the characteristic vectors, preset by a technical personnel based on statistics on a large amount of data and stored into the electronic device.

In some alternative implementations of the present embodiment, the vehicle accident loss value within the preset period calculation model may be the Tweedie distribution.

Based on the above alternative implementations, in some alternative implementations of the present embodiment, the vehicle accident loss value within the preset period calculation model may be obtained by using the following third training steps.

First, an initial value of a parameter of the Tweedie distribution and a predetermined third sample data set may be acquired. Here, each piece of sample data in the third sample data set includes a characteristic vector of a user and a historical vehicle accident loss value within preset time of the user (for example, a historical vehicle insurance annualized compensation amount). Here, the characteristic vector of the user is a characteristic vector obtained by splicing a score corresponding to each personal attribute characteristic of the at least one personal attribute characteristic of the user and the vehicle attribute characteristic.

Then, the characteristic vector of the user in each piece of sample data in the third sample data set is used as input data, and the historical vehicle accident loss value of the user within preset time in the sample data is used as corresponding output data to train the parameter of the Tweedie distribution.

Finally, the trained Tweedie distribution is defined as the pre-trained vehicle accident loss value within preset time calculation model.

Step 205, outputting at least one obtained prediction value.

In the present embodiment, the electronic device may output at least one prediction value obtained in step 204.

In some alternative implementations of the present embodiment, the at least one prediction value may be presented in the electronic device (e.g., in a display screen of the electronic device).

In some alternative implementations of the present embodiment, the electronic device may also send the at least one prediction value to other electronic devices connected to the electronic device via the network, for the other electronic devices to receive and present the at least one prediction value.

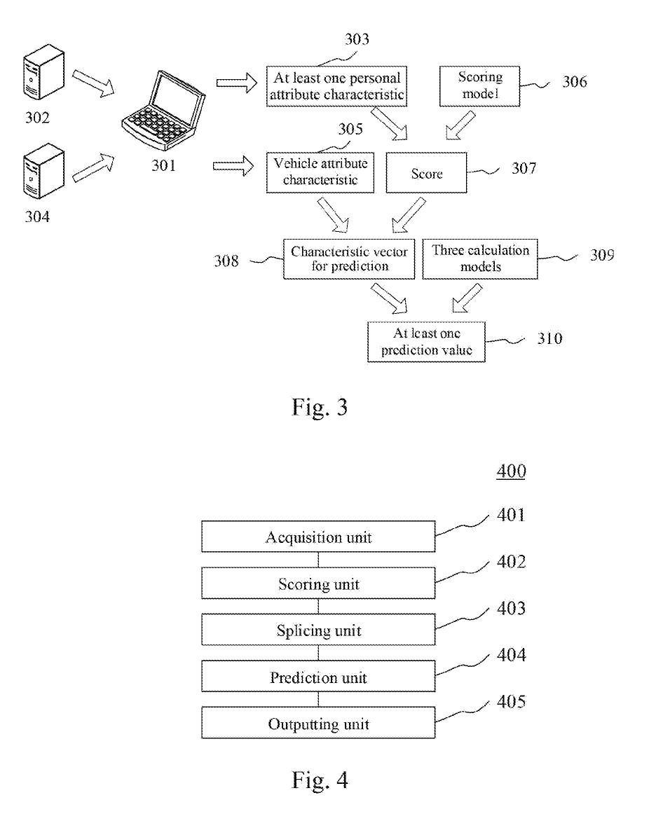

With further reference to FIG. 3, FIG. 3 is a schematic diagram of an application scenario of the method for outputting information according to the present embodiment. In the application scenario of FIG. 3, first, the electronic device 301 acquires at least one personal attribute characteristic 303 of the target user from a big data server 302, and acquires a vehicle attribute characteristic 305 of the target user from a vehicle insurance company server 304. Then, the electronic device 301 imports, for each personal attribute characteristic of the at least one personal attribute characteristic 303, the personal attribute characteristic into a pre-trained scoring model 306 to obtain a score 307 corresponding to the personal attribute characteristic. Next, the electronic device 301 splices the score 307 corresponding to each of the at least one personal attribute characteristic and the vehicle attribute characteristic 305 to obtain a characteristic vector for prediction 308. Then, the electronic device 301 imports the characteristic vector for prediction 308 into at least one of three pre-trained calculation models 309 to obtain a prediction value 310 corresponding to each calculation model of the at least one calculation model into which the characteristic vector for prediction is imported. Finally, the at least one obtained prediction value 310 is outputted.

The method provided by the embodiments of the present disclosure achieve dimension reduction by using a method of scoring each personal attribute characteristic of at least one personal attribute characteristic of the target user, realize compressing a personal attribute characteristic with high and sparse characteristic dimension into an one-dimensional score, then splice the score corresponding to each personal attribute characteristic of the at least one personal attribute characteristic and a vehicle attribute characteristic with low and dense characteristic dimension, so that the characteristic vector obtained after the splicing is a characteristic vector with low and dense characteristic dimension. Then, the characteristic vector obtained after the splicing is defined as a characteristic vector for prediction and the characteristic vector for prediction is imported into at least one of three pre-trained calculation models to obtain a prediction value corresponding to each calculation model of the at least one calculation model into which the characteristic vector for prediction is imported, and the at least one obtained prediction value is outputted. Therefore, the personal attribute characteristic with high and sparse characteristic dimension is effectively utilized, and at least one of the three prediction values is obtained by combining the vehicle attribute characteristic, thereby improving the content richness of the information output.

With further reference to FIG. 4, as an implementation to the method shown in the above figures, the present disclosure provides an embodiment of an apparatus for outputting information. The apparatus embodiment corresponds to the method embodiment shown in FIG. 2, and the apparatus may specifically be applied to various electronic devices.

As shown in FIG. 4, the apparatus 400 for outputting information of the present embodiment includes: an acquisition unit 401, a scoring unit 402, a splicing unit 403, a prediction unit 404 and an outputting unit 405. The acquisition unit 401 is configured to acquire at least one personal attribute characteristic and a vehicle attribute characteristic of a target user. The scoring unit 402 is configured to import, for each personal attribute characteristic of the at least one personal attribute characteristic, the personal attribute characteristic into a pre-trained scoring model to obtain a score corresponding to the personal attribute characteristic, the scoring model being used to represent a corresponding relationship between the personal attribute characteristic and the score. The splicing unit 403 is configured to define a characteristic vector obtained by splicing the score corresponding to each personal attribute characteristic of the at least one personal attribute characteristic and the vehicle attribute characteristic as a characteristic vector for prediction. The prediction unit 404 is configured to import the characteristic vector for prediction into at least one of three pre-trained calculation models to obtain a prediction value corresponding to each calculation model of the at least one calculation model into which the characteristic vector for prediction is imported. The three calculation models includes: a vehicle accident occurrence frequency calculation model, an average vehicle accident loss value calculation model, and a vehicle accident loss value within a preset period calculation model. The vehicle accident occurrence frequency calculation model is used to represent a corresponding relationship between the characteristic vector and a vehicle accident occurrence frequency. The average vehicle accident loss value calculation model is used to represent a corresponding relationship between the characteristic vector and an average vehicle accident loss value. The vehicle accident loss value within the preset period calculation model is used to represent a corresponding relationship between the characteristic vector and a vehicle accident loss value within preset time. The outputting unit 405 is configured to output at least one obtained prediction value.

In the present embodiment, the specific processing and the technical effects thereof of the acquisition unit 401, the scoring unit 402, the splicing unit 403, the prediction unit 404 and the outputting unit 405 of the apparatus 400 for outputting information may be referred to the related descriptions of step 201, step 202, step 203, step 204 and step 205 in the corresponding embodiment of FIG. 2, respectively, and detailed description thereof will be omitted.

In some alternative implementations of the present embodiment, the at least one personal attribute characteristic may include at least one of: a natural personal attribute characteristic or a network behavior characteristic, and the network behavior characteristic may include at least one of: an electronic map navigation characteristic, an interests profile characteristic, an address characteristic, a common application characteristic, a credit score characteristic or a network search topic characteristic.

In some alternative implementations of the present embodiment, the vehicle accident occurrence frequency calculation model may be a Poisson distribution, the average vehicle accident loss value calculation model may be a gamma distribution, and the vehicle accident loss value within the preset period calculation model may be a Tweedie distribution.

In some alternative implementations of the present embodiment, the vehicle accident occurrence frequency calculation model may be obtained by: acquiring an initial value of a parameter of the Poisson distribution and a predetermined first sample data set, wherein each piece of sample data in the first sample data set includes a characteristic vector of a user and a historical vehicle accident occurrence frequency of the user, wherein the characteristic vector of the user is obtained by splicing a score corresponding to each personal attribute characteristic of the at least one personal attribute characteristic of the user and the vehicle attribute characteristic; using the characteristic vector of the user in each piece of sample data in the first sample data set as input data, and the historical vehicle accident occurrence frequency of the user in the sample data as corresponding output data to train the parameter of the Poisson distribution; and defining the trained Poisson distribution as the pre-trained vehicle accident occurrence frequency calculation model.

In some alternative implementations of the present embodiment, the average vehicle accident loss value calculation model may be obtained by: acquiring an initial value of a parameter of the gamma distribution and a predetermined second sample data set, wherein each piece of sample data in the second sample data set includes a characteristic vector of a user and a historical average vehicle accident loss value of the user, wherein the characteristic vector of the user is obtained by splicing a score corresponding to each personal attribute characteristic of the at least one personal attribute characteristic of the user and the vehicle attribute characteristic; using the characteristic vector of the user in each piece of sample data in the second sample data set as input data, and the historical average vehicle accident loss value of the user in the sample data as corresponding output data to train the parameter of the gamma distribution; and defining the trained gamma distribution as the pre-trained average vehicle accident loss value calculation model.

In some alternative implementations of the present embodiment, the vehicle accident loss value within the preset period calculation model may be obtained by: acquiring an initial value of a parameter of the Tweedie distribution and a predetermined third sample data set, wherein each piece of sample data in the third sample data set includes a characteristic vector of a user and a historical vehicle accident loss value within preset time of the user, wherein the characteristic vector of the user is obtained by splicing a score corresponding to each personal attribute characteristic of the at least one personal attribute characteristic of the user and the vehicle attribute characteristic; using the characteristic vector of the user in each piece of sample data in the third sample data set as input data, and the historical vehicle accident loss value within preset time of the user in the sample data as corresponding output data to train the parameter of the Tweedie distribution; and defining the trained Tweedie distribution as the pre-trained vehicle accident loss value within preset time calculation model.

In some alternative implementations of the present embodiment, the vehicle attribute characteristic may include at least one of: a vehicle model, a number of compartments, a vehicle displacement, or historical vehicle accident related information.

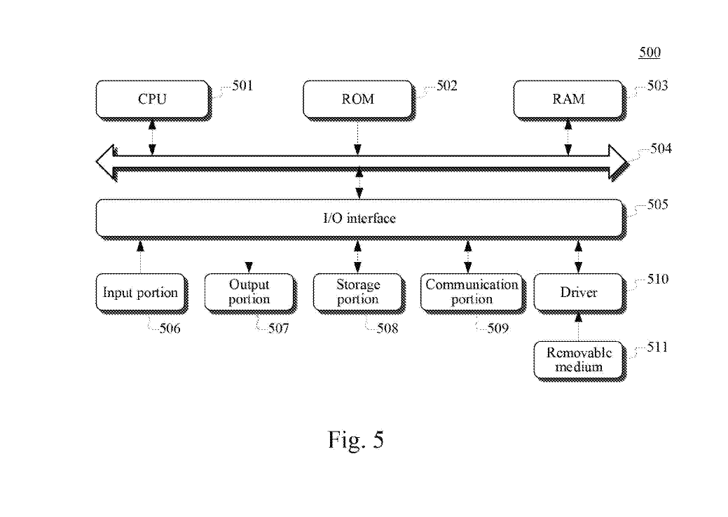

Referring to FIG. 5, which is a schematic structural diagram of a computer system 500 adapted to implement an electronic device according to embodiments of the present disclosure. The electronic device shown in FIG. 5 is merely an example, and should not bring any limitations to the functions and the scope of use of the embodiments of the present disclosure.

As shown in FIG. 5, the computer system 500 includes a central processing unit (CPU) 501, which may execute various appropriate actions and processes in accordance with a program stored in a read-only memory (ROM) 502 or a program loaded into a random access memory (RAM) 503 from a storage portion 508. The RAM 503 also stores various programs and data required by operations of the system 500. The CPU 501, the ROM 502 and the RAM 503 are connected to each other through a bus 504. An input/output (I/O) interface 505 is also connected to the bus 504.

The following components are connected to the I/O interface 505: an input portion 506 including a keyboard, a mouse etc.; an output portion 507 comprising a cathode ray tube (CRT), a liquid crystal display device (LCD), a speaker etc.; a storage portion 508 including a hard disk and the like; and a communication portion 509 comprising a network interface card, such as a LAN card and a modem. The communication portion 509 performs communication processes via a network, such as the Internet. A driver 510 is also connected to the I/O interface 505 as required. A removable medium 511, such as a magnetic disk, an optical disk, a magneto-optical disk, and a semiconductor memory, may be installed on the driver 510, to facilitate the retrieval of a computer program from the removable medium 511, and the installation thereof on the storage portion 508 as needed.

In particular, according to embodiments of the present disclosure, the process described above with reference to the flow chart may be implemented in a computer software program. For example, an embodiment of the present disclosure includes a computer program product, which comprises a computer program that is tangibly embedded in a machine-readable medium. The computer program comprises program codes for executing the method as illustrated in the flow chart. In such an embodiment, the computer program may be downloaded and installed from a network via the communication portion 509, and/or may be installed from the removable media 511. The computer program, when executed by the central processing unit (CPU) 501, implements the above mentioned functionalities as defined by the methods of the present disclosure. It should be noted that the computer readable medium in the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fiber, a portable compact disk read only memory (CD-ROM), an optical memory, a magnet memory or any suitable combination of the above. In the present disclosure, the computer readable storage medium may be any physical medium containing or storing programs which can be used by a command execution system, apparatus or element or incorporated thereto. In the present disclosure, the computer readable signal medium may include data signal in the base band or propagating as parts of a carrier, in which computer readable program codes are carried. The propagating signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system executing specified functions or operations, or by a combination of a dedicated hardware and computer instructions.

The units involved in the embodiments of the present disclosure may be implemented by means of software or hardware. The described units may also be provided in a processor, for example, described as: a processor, comprising an acquisition unit, a scoring unit, a splicing unit, a prediction unit, and an outputting unit, where the names of these units do not in some cases constitute a limitation to such units themselves. For example, the outputting unit may also be described as “a unit for outputting a prediction value.”

In another aspect, the present disclosure further provides a computer-readable storage medium. The computer-readable storage medium may be the computer storage medium included in the apparatus in the above described embodiments, or a stand-alone computer-readable storage medium not assembled into the apparatus. The computer-readable storage medium stores one or more programs. The one or more programs, when executed by an apparatus, cause the apparatus to: acquiring at least one personal attribute characteristic and a vehicle attribute characteristic of a target user; importing, for each personal attribute characteristic of the at least one personal attribute characteristic, the personal attribute characteristic into a pre-trained scoring model to obtain a score corresponding to the personal attribute characteristic, the scoring model being used to represent a corresponding relationship between the personal attribute characteristic and the score; defining a characteristic vector obtained by splicing the score corresponding to each personal attribute characteristic of the at least one personal attribute characteristic and the vehicle attribute characteristic as a characteristic vector for prediction; importing the characteristic vector for prediction into at least one of three pre-trained calculation models to obtain a prediction value corresponding to each calculation model of the at least one calculation model into which the characteristic vector for prediction is imported, the three calculation models comprising: a vehicle accident occurrence frequency calculation model, an average vehicle accident loss value calculation model, and a vehicle accident loss value within a preset period calculation model, the vehicle accident occurrence frequency calculation model being used to represent a corresponding relationship between the characteristic vector and a vehicle accident occurrence frequency, the average vehicle accident loss value calculation model being used to represent a corresponding relationship between the characteristic vector and an average vehicle accident loss value, and the vehicle accident loss value within the preset period calculation model being used to represent a corresponding relationship between the characteristic vector and a vehicle accident loss value within preset time; and outputting at least one obtained prediction value.

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the present disclosure are examples.

What is claimed is:

1. A method for outputting information, the method comprising:
acquiring at least one personal attribute characteristic and a vehicle attribute characteristic of a target user;
importing, for each personal attribute characteristic of the at least one personal attribute characteristic, the personal attribute characteristic into a pre-trained scoring model to obtain a score corresponding to the personal attribute characteristic, the scoring model being used to represent a corresponding relationship between the personal attribute characteristic and the score;
defining a characteristic vector obtained by splicing the score corresponding to each personal attribute characteristic of the at least one personal attribute characteristic and the vehicle attribute characteristic as a characteristic vector for prediction;
importing the characteristic vector for prediction into at least one of three pre-trained calculation models to obtain a prediction value corresponding to each calculation model of the at least one calculation model into which the characteristic vector for prediction is imported, the three calculation models comprising: a vehicle accident occurrence frequency calculation model, an average vehicle accident loss value calculation model, and a vehicle accident loss value within a preset period calculation model, the vehicle accident occurrence frequency calculation model being used to represent a corresponding relationship between the characteristic vector and a vehicle accident occurrence frequency, the average vehicle accident loss value calculation model being used to represent a corresponding relationship between the characteristic vector and an average vehicle accident loss value, and the vehicle accident loss value within the preset period calculation model being used to represent a corresponding relationship between the characteristic vector and a vehicle accident loss value within preset time; and
outputting at least one obtained prediction value.

2. The method according to claim 1, wherein the at least one personal attribute characteristic comprises at least one of: a natural personal attribute characteristic or a network behavior characteristic, and the network behavior characteristic comprises at least one of: an electronic map navigation characteristic, an interests profile characteristic, an address characteristic, a common application characteristic, a credit score characteristic or a network search topic characteristic.

3. The method according to claim 2, wherein the vehicle accident occurrence frequency calculation model is a Poisson distribution, the average vehicle accident loss value calculation model is a gamma distribution, and the vehicle accident loss value within the preset period calculation model is a Tweedie distribution.

4. The method according to claim 3, wherein the vehicle accident occurrence frequency calculation model is obtained by:
acquiring an initial value of a parameter of the Poisson distribution and a predetermined first sample data set, wherein each piece of sample data in the first sample data set comprises a characteristic vector of a user and a historical vehicle accident occurrence frequency of the user, wherein the characteristic vector of the user is obtained by splicing the score corresponding to the each personal attribute characteristic of the at least one personal attribute characteristic of the user and the vehicle attribute characteristic;
using the characteristic vector of the user in each piece of sample data in the first sample data set as input data, and the historical vehicle accident occurrence frequency of the user in the sample data as corresponding output data to train the parameter of the Poisson distribution; and
defining the trained Poisson distribution as the pre-trained vehicle accident occurrence frequency calculation model.

5. The method according to claim 4, wherein the average vehicle accident loss value calculation model is obtained by:
acquiring an initial value of a parameter of the gamma distribution and a predetermined second sample data set, wherein each piece of sample data in the second sample data set comprises a characteristic vector of a user and a historical average vehicle accident loss value of the user, wherein the characteristic vector of the user is obtained by splicing the score corresponding to the each personal attribute characteristic of the at least one personal attribute characteristic of the user and the vehicle attribute characteristic;
using the characteristic vector of the user in each piece of sample data in the second sample data set as input data, and the historical average vehicle accident loss value of the user in the sample data as corresponding output data to train the parameter of the gamma distribution; and
defining the trained gamma distribution as the pre-trained average vehicle accident loss value calculation model.

6. The method according to claim 5, wherein the vehicle accident loss value within the preset period calculation model is obtained by:
acquiring an initial value of a parameter of the Tweedie distribution and a predetermined third sample data set, wherein each piece of sample data in the third sample data set comprises a characteristic vector of a user and a historical vehicle accident loss value within preset time of the user, wherein the characteristic vector of the user is obtained by splicing the score corresponding to the each personal attribute characteristic of the at least one personal attribute characteristic of the user and the vehicle attribute characteristic;
using the characteristic vector of the user in each piece of sample data in the third sample data set as input data, and the historical vehicle accident loss value within preset time of the user in the sample data as corresponding output data to train the parameter of the Tweedie distribution; and
defining the trained Tweedie distribution as the pre-trained vehicle accident loss value within preset time calculation model.

7. The method according to claim 6, wherein the vehicle attribute characteristic comprises at least one of: a vehicle model, a number of compartments, a vehicle displacement, or historical vehicle accident related information.

8. An apparatus for outputting information, the apparatus comprising:
at least one processor; and
a memory storing instructions, the instructions when executed by the at least one processor, cause the at least one processor to perform operations, the operations comprising:
acquiring at least one personal attribute characteristic and a vehicle attribute characteristic of a target user;
importing, for each personal attribute characteristic of the at least one personal attribute characteristic, the personal attribute characteristic into a pre-trained scoring model to obtain a score corresponding to the personal attribute characteristic, the scoring model being used to represent a corresponding relationship between the personal attribute characteristic and the score;
defining a characteristic vector obtained by splicing the score corresponding to each personal attribute characteristic of the at least one personal attribute characteristic and the vehicle attribute characteristic as a characteristic vector for prediction;
importing the characteristic vector for prediction into at least one of three pre-trained calculation models to obtain a prediction value corresponding to each calculation model of the at least one calculation model into which the characteristic vector for prediction is imported, the three calculation models comprising: a vehicle accident occurrence frequency calculation model, an average vehicle accident loss value calculation model, and a vehicle accident loss value within a preset period calculation model, the vehicle accident occurrence frequency calculation model being used to represent a corresponding relationship between the characteristic vector and a vehicle accident occurrence frequency, the average vehicle accident loss value calculation model being used to represent a corresponding relationship between the characteristic vector and an average vehicle accident loss value, and the vehicle accident loss value within the preset period calculation model being used to represent a corresponding relationship between the characteristic vector and a vehicle accident loss value within preset time; and
outputting at least one obtained prediction value.

9. The apparatus according to claim 8, wherein the at least one personal attribute characteristic comprises at least one of: a natural personal attribute characteristic or a network behavior characteristic, and the network behavior characteristic comprises at least one of: an electronic map navigation characteristic, an interests profile characteristic, an address characteristic, a common application characteristic, a credit score characteristic or a network search topic characteristic.

10. The apparatus according to claim 9, wherein the vehicle accident occurrence frequency calculation model is a Poisson distribution, the average vehicle accident loss value calculation model is a gamma distribution, and the vehicle accident loss value within the preset period calculation model is a Tweedie distribution.

11. The apparatus according to claim 10, wherein the vehicle accident occurrence frequency calculation model is obtained by:
acquiring an initial value of a parameter of the Poisson distribution and a predetermined first sample data set, wherein each piece of sample data in the first sample data set comprises a characteristic vector of a user and a historical vehicle accident occurrence frequency of the user, wherein the characteristic vector of the user is obtained by splicing the score corresponding to the each personal attribute characteristic of the at least one personal attribute characteristic of the user and the vehicle attribute characteristic;
using the characteristic vector of the user in each piece of sample data in the first sample data set as input data, and the historical vehicle accident occurrence frequency of the user in the sample data as corresponding output data to train the parameter of the Poisson distribution; and
defining the trained Poisson distribution as the pre-trained vehicle accident occurrence frequency calculation model.

12. The apparatus according to claim 11, wherein the average vehicle accident loss value calculation model is obtained by:
acquiring an initial value of a parameter of the gamma distribution and a predetermined second sample data set, wherein each piece of sample data in the second sample data set comprises a characteristic vector of a user and a historical average vehicle accident loss value of the user, wherein the characteristic vector of the user is obtained by splicing the score corresponding to the each personal attribute characteristic of the at least one personal attribute characteristic of the user and the vehicle attribute characteristic;
using the characteristic vector of the user in each piece of sample data in the second sample data set as input data, and the historical average vehicle accident loss value of the user in the sample data as corresponding output data to train the parameter of the gamma distribution; and
defining the trained gamma distribution as the pre-trained average vehicle accident loss value calculation model.

13. The apparatus according to claim 12, wherein the vehicle accident loss value within the preset period calculation model is obtained by:
acquiring an initial value of a parameter of the Tweedie distribution and a predetermined third sample data set, wherein each piece of sample data in the third sample data set comprises a characteristic vector of a user and a historical vehicle accident loss value within preset time of the user, wherein the characteristic vector of the user is obtained by splicing the score corresponding to the each personal attribute characteristic of the at least one personal attribute characteristic of the user and the vehicle attribute characteristic;
using the characteristic vector of the user in each piece of sample data in the third sample data set as input data, and the historical vehicle accident loss value within preset time of the user in the sample data as corresponding output data to train the parameter of the Tweedie distribution; and
defining the trained Tweedie distribution as the pre-trained vehicle accident loss value within preset time calculation model.

14. The apparatus according to claim 13, wherein the vehicle attribute characteristic comprises at least one of: a vehicle model, a number of compartments, a vehicle displacement, or historical vehicle accident related information.

15. A non-transitory computer storage medium storing a computer program, the computer program when executed by one or more processors, causes the one or more processors to perform operations, the operations comprising:
acquiring at least one personal attribute characteristic and a vehicle attribute characteristic of a target user;
importing, for each personal attribute characteristic of the at least one personal attribute characteristic, the personal attribute characteristic into a pre-trained scoring model to obtain a score corresponding to the personal attribute characteristic, the scoring model being used to represent a corresponding relationship between the personal attribute characteristic and the score;
defining a characteristic vector obtained by splicing the score corresponding to each personal attribute characteristic of the at least one personal attribute characteristic and the vehicle attribute characteristic as a characteristic vector for prediction;
importing the characteristic vector for prediction into at least one of three pre-trained calculation models to obtain a prediction value corresponding to each calculation model of the at least one calculation model into which the characteristic vector for prediction is imported, the three calculation models comprising: a vehicle accident occurrence frequency calculation model, an average vehicle accident loss value calculation model, and a vehicle accident loss value within a preset period calculation model, the vehicle accident occurrence frequency calculation model being used to represent a corresponding relationship between the characteristic vector and a vehicle accident occurrence frequency, the average vehicle accident loss value calculation model being used to represent a corresponding relationship between the characteristic vector and an average vehicle accident loss value, and the vehicle accident loss value within the preset period calculation model being used to represent a corresponding relationship between the characteristic vector and a vehicle accident loss value within preset time; and
outputting at least one obtained prediction value.
